(19) United States
(12) Patent Application Publication
(10) Pub. No.: US 2020/0039469 A1
(43) Pub. Date: Feb. 6, 2020

(54) INTUITIVE REMOTE START SUGGESTIONS WITH SMART-PHONE APPLICATION

(71) Applicant: GM Global Technology Operations LLC, Detroit, MI (US)

(72) Inventors: Robert L. Cowing, Berkley, MI (US); Matt Neely, Rochester, MI (US); Eric T. Hosey, Royal Oak, MI (US); Russell A. Patenaude, Macomb Township, MI (US)

(21) Appl. No.: 16/052,939

(22) Filed: Aug. 2, 2018

(51) Int. Cl. B60R 25/20; B60R 25/04; B60R 25/24; G07C 5/00

(52) U.S. Cl. CPC B60R 25/209; B60R 25/04; B60R 2025/0405; G07C 5/008; B60R 25/246

(57) ABSTRACT

A method for controlling an automobile vehicle remote-start operation includes linking a personal communication device of a user to an automobile vehicle. Data directed to initiation of an automobile vehicle remote start operation is collected on the personal communication device. The data is compared to a predetermined threshold. If the predetermined threshold is met, a screen prompt is generated and displayed on the personal communication device of the user requesting the user to initiate the remote-start operation. The remote-start operation is initiated by the user from the personal communication device.

### INTRODUCTION

The present disclosure relates to automobile vehicle remote-start systems and methods of operation.

Smart-phones, tablets and similar hand-held electronic devices can include programs or applications to remote-start an automobile vehicle. Such applications normally provide to a user information such as the vehicle start-stop condition, and may provide information relating to a time the vehicle has been running, or, if the vehicle exceeds a predetermined run time after a remote-start, the application may indicate the vehicle has been shut down. Two of the principle benefits of a remote-start application are to allow the vehicle to warm-up during cold weather or to cool-down during hot weather operation prior to the user entering the vehicle. It is common for vehicle owners or operators using such applications to forget to initiate the remote-start operation from their phone or electronic device until they are too close to the vehicle to add significant benefit from doing so.

Thus, while current vehicle remote-start applications achieve their intended purpose, there is a need for a new and improved system and method for identifying to a user when a remote-start operation is available that precludes the user arriving at the vehicle before realizing the remote-start operation was not initiated.

### SUMMARY

According to several aspects, a method for controlling an automobile vehicle remote-start operation includes: collecting data directed to initiation of an automobile vehicle remote start operation; comparing the data to at least one predetermined threshold; and if the predetermined threshold is met, generating a screen prompt displayed on a personal communication device of a user of the automobile vehicle requesting the user to initiate the remote-start operation.

In another aspect of the present disclosure, the method further includes designating the data as a quantity of steps taken by the user following a vehicle shut-off.

In another aspect of the present disclosure, the method further includes setting as the predetermined threshold a minimum quantity of the steps.

In another aspect of the present disclosure, the method further includes setting as the predetermined threshold a time range within which to count the minimum quantity of the steps.

In another aspect of the present disclosure, the method further includes designating the data as a barometric pressure data set defining an elevation between the vehicle and the personal communication device of the user.

In another aspect of the present disclosure, the method further includes setting as the predetermined threshold an elevation difference between the elevation of the vehicle and the elevation of the personal communication device of the user.

In another aspect of the present disclosure, the method further includes: designating the data as at least one of a work start time and a work end time of the user; and setting as the predetermined threshold a predetermined time period ahead of the at least one of the work start time and the work end time.

In another aspect of the present disclosure, the method further includes: detecting if the user started the vehicle but did not enter the vehicle; and timing-out the remote-start operation when the user does not enter the vehicle within a predetermined time interval.

In another aspect of the present disclosure, the method further includes generating a repeat screen prompt to request the user to repeat the remote start operation.

In another aspect of the present disclosure, the method further includes: designating the data as a user distance between the user and the vehicle; initiating a timer when the user parks and leaves the vehicle; defining a radius around the vehicle after the user has moved the user distance away from the vehicle; and setting as the predetermined threshold a determination that the user has returned within the radius defining the user distance.

According to several aspects, a method for controlling an automobile vehicle remote-start operation includes: linking a personal communication device of a user to an automobile vehicle; collecting data directed to initiation of an automobile vehicle remote start operation on the personal communication device; comparing the data to a predetermined threshold; if the predetermined threshold is met, generating a screen prompt and displaying the screen prompt on the personal communication device of the user requesting the user to initiate the remote-start operation; and initiating the remote-start operation by the user from the personal communication device.

In another aspect of the present disclosure, the method further includes: designating the data as a quantity of steps taken by the user following a vehicle shut-off; and setting as the predetermined threshold a minimum quantity of the steps.

In another aspect of the present disclosure, the method further includes: designating the data as a user distance the user has moved away from the vehicle; setting a calculated time for the user to reach the user distance defining “X” minutes; and defining the predetermined threshold as a predetermined time when the user will return to the vehicle.

In another aspect of the present disclosure, the method further includes: identifying the user has returned within the user distance confirming the predetermined threshold is met; and performing the generating step “X” minutes ahead of the predetermined time.

In another aspect of the present disclosure, the predetermined threshold includes: a first barometric pressure identified at a location where the vehicle is shut-off; and a second barometric pressure confirmed at a second location designated by the user different from the first barometric pressure.

In another aspect of the present disclosure, the predetermined threshold is met when a predetermined third barometric pressure between the first barometric pressure and the second barometric pressure is identified by the personal communication device of the user indicating the user is returning to the vehicle.

In another aspect of the present disclosure, the method further includes: designating the data as a quantity of steps taken by the user following a vehicle shut-off; setting a user designated step cut-off level; and applying the step cut-off level to automatically omit a count of the steps below a predetermined number of steps from generating the screen prompt.

According to several aspects, a system for controlling an automobile vehicle remote-start operation includes a personal communication device of a user linked to an automobile vehicle. A data set directed to initiation of an automobile vehicle remote start operation is collected on the personal communication device. A predetermined threshold is compared to the data set. A screen prompt is generated by the personal communication device if the predetermined threshold is met, the screen prompt displayed on the personal communication device of the user, the screen prompt requesting the user to initiate the remote-start operation. A selection of the screen prompt by the user acts to initiate the remote-start operation from the personal communication device.

In another aspect of the present disclosure, the data set defines a quantity of steps taken by the user following a vehicle shut-off; and the predetermined threshold defines a minimum quantity of the steps.

In another aspect of the present disclosure, the data set defines at least one of a work start time and a work end time of the user; and the predetermined threshold defines a predetermined time period ahead of the at least one of the work start time and the work end time.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a side elevational view of an automobile vehicle remote-start system according to an exemplary embodiment;

FIG. 2 is a flow diagram of the remote-start system of FIG. 1;

FIG. 3 is a second flow diagram of the remote-start system of FIG. 1; and

FIG. 4 is a graph of an exemplary user work day employing a step counter of the remote-start program of FIG. 1.

### DETAILED DESCRIPTION

The following description is merely exemplary in nature and is not intended to limit the present disclosure, application, or uses.

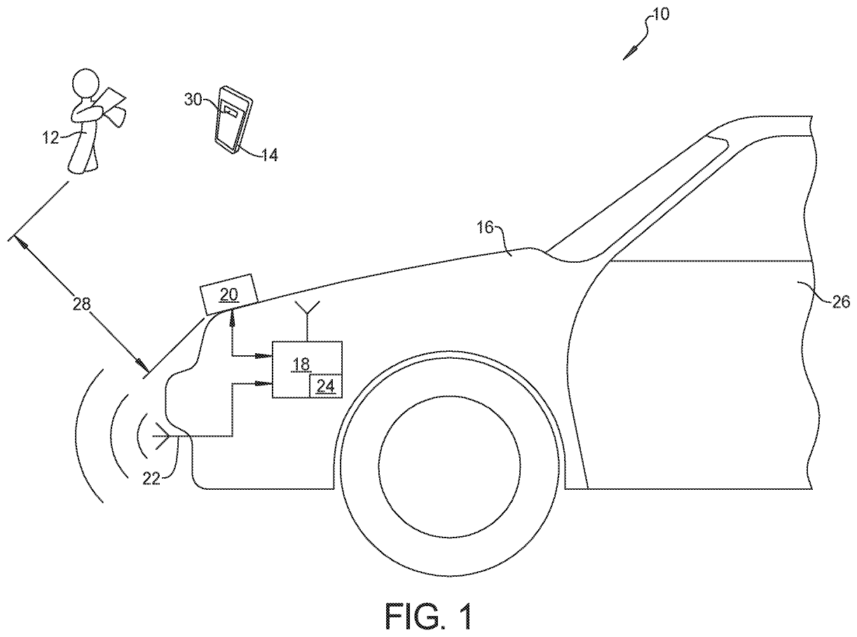

Referring to FIG. 1, an intuitive remote start suggestions with smart-phone application or remote-start program 10 provides for wireless communication between a user 12 having a personal communication device 14 such as a smart-phone or tablet and an automobile vehicle 16. The personal communication device 14 incorporates software and hardware for the remote-start program 10 to provide commands to remote-start an engine 18 of the vehicle 16. The vehicle 16 is therefore equipped with a communication system 20 having for example a receiver-transmitter and an antenna 22 or similar wireless communication feature. An engine control system 24 receives commands from the communication system 20 sent by the personal communication device 14 and initiates operation of the engine 18, for example to provide remote start for either warm-up or cool-down of an interior compartment 26 of the vehicle 16, or for warm-up of the engine 18.

The communication system 20 also communicates vehicle information to the personal communication device 14, such as for example confirmation of engine start or engine stop and to track a user distance 28 between the personal communication device 14 and the vehicle 16. According to several aspects, the remote-start program 10 generates a screen prompt 30 on a view screen of the personal communication device 14 at various times to be further discussed herein to determine if the user 12 wishes to perform a remote start operation.

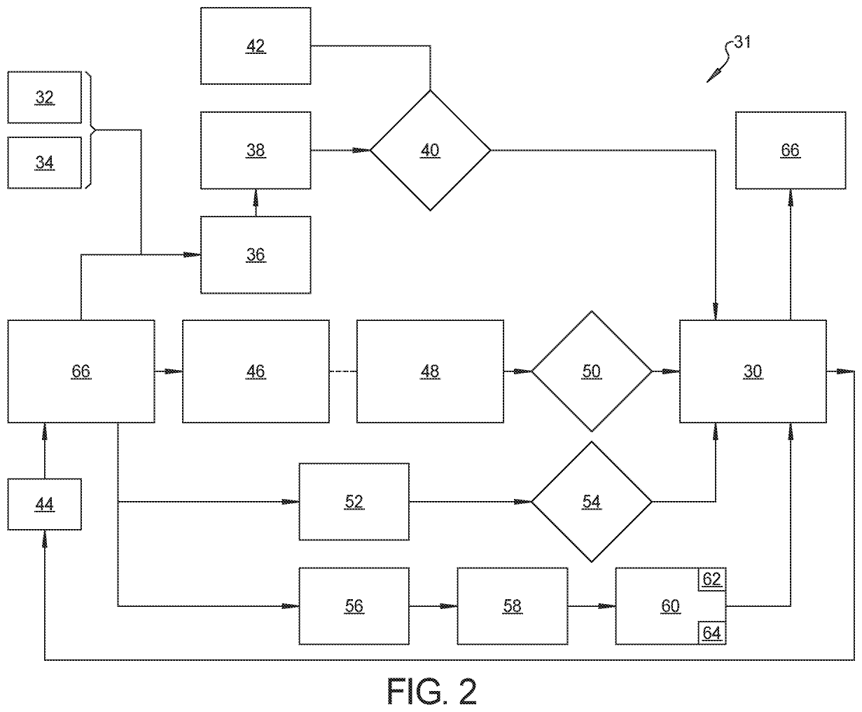

Referring to FIG. 2 and again to FIG. 1, a flow chart 31 provides multiple steps taken by the remote-start program 10 to monitor to determine when to produce the screen prompt 30. The remote-start program 10 may be provided as an application downloaded onto the personal communication device 14, and provides a step-counter 32 and a timer 34. The application or remote-start program 10 measures in a step 36 if a predetermined quantity of steps of the user 12 meeting a step threshold 38 has been met or exceeded. The remote-start program 10 provides a predetermined step threshold which the user can select, or the user 12 can change or pre-set the step threshold 38. The remote-start program 10 tracks a step-counter dataset 40 and applies an average distance per step retrieved from a memory 42 to calculate the user distance 28 from the vehicle 16, and from the timer 34 identifies a time to reach the user distance 28, and saves this information in the memory 42. A run-time may also be a predetermined time retrieved from the memory 42 which is required for the vehicle 16 to heat up or cool down after a remote-start. According to several aspects, when the user 12 returns to within the user distance 28 from the vehicle 16 the remote-start program 10 generates the screen prompt 30 asking the user 12 if a remote-start is desired. If the screen prompt 30 is actuated, an engine remote-start operation 44 is selected, which permits the engine 18 to start to either heat up or cool down the interior compartment 26 of the vehicle 16 during the anticipated time it will take the user 12 to return to the vehicle 16 based on the step threshold 38.

The remote-start program 10 further incorporates barometric pressure data 46 to identify in a step 48 if the user 12 is moving up or down within a zone with respect to the vehicle 16. Such a zone may include the user 12 being within a high-rise building or a parking garage. If the user 12 works for example in a high-rise building and the remote-start program 10 determines in the step 48 that the user 12 moves a predetermined height or elevation defining a predefined threshold 50 to reach a work area, such as the user moving upward to a twenty fifth floor office, the remote-start program 10 will set the barometric pressure data 46 defining an elevation difference between the vehicle 16 and the personal communication device 14 of the user 12. For example, a barometric pressure data set defines a first elevation of the vehicle and a second elevation of the personal communication device 14 of the user. The predetermined threshold 50 can be met for example when a predetermined third barometric pressure between the first barometric pressure and the second barometric pressure is identified by the personal communication device 14 of the user 12 indicating the user 12 is returning to the vehicle.

The barometric pressure data 46 can be used alone or in combination with a predetermined time (start and stop work times for example as discussed below), to generate the screen prompt 30 asking if the user 12 desires to initiate the remote-start operation 44 when the barometric pressure data 46 indicates the user 12 is for example once again descending or ascending toward the elevation at which the vehicle 16 is located.

As an example, the user 12 works on a twenty fifth floor of a high rise building, and parks in a parking garage at a ground level. If the barometric pressure data 46 is set as a condition for generating the screen prompt 30, the screen prompt 30 will be generated when the barometric pressure data 46 changes by the predefined threshold 50 indicating the user is leaving the twenty fifth floor elevation and returning to the ground level elevation where the vehicle 16 is parked. To avoid prompts when the user is merely moving between floors during the workday, such as to attend meetings on lower building floors, the barometric pressure predefined threshold 50 can be set such that the screen prompt 30 will be generated only if the user 12 moves below an elevation defining a tenth floor elevation for example. The user's work schedule time can also be used as a modifier, such that if the user 12 normally leaves work at 4:30 pm and sets the remote-start program 10 to deliver the screen prompt 30 for a remote-start at 4:30 pm each weekday, a barometric pressure change occurring before 4:30 pm will not generate the screen prompt 30.

The remote-start program 10 also retrieves data from a user schedule 52 which the user 12 populates with information, such as a user work start time and user work stop time, normal routine events such as exercise times, school pick-up times, and the like. For example the user 12 can input and save work day vehicle start times to conduct the remote-start operation 44 each weekday morning, Monday through Friday at 6:30 am, and an end of work day vehicle start time of 4:30 pm. In a determination step 54, when any of these times is determined to have been reached, the screen prompt 30 is generated asking the user on each of these days of the week if the remote-start operation 44 is desired. The data reviewed by the program 10 can therefore be designated as at least one of a work start time and a work end time of the user. The user 12 can set as the predetermined threshold a predetermined time period (for example 15 minutes) ahead of the work start time or the work end time to generate the screen prompt 30, which provides sufficient time for engine warm-up, cabin warm-up or cabin cool-down.

In a tracking step 56, the remote-start program 10 also tracks weather conditions such as an ambient temperature 58. When the ambient temperature 58 is either below or above a user predetermined ambient temperature threshold 60 retrieved from the memory 42 the screen prompt 30 is generated requesting if the user wants to conduct a remote-start to warm or cool the vehicle 16 prior to departure. This information can be used alone or in combination with other predetermined conditions. For example, the user 12 can set the above workday information as repetitious requests for a remote-start prompt, however, if the ambient weather conditions do not drop below or exceed the predetermined ambient temperature threshold 60 indicating the need for the remote-start operation 44, no prompt is generated on those weekdays. The predetermined ambient temperature threshold 60 can be for example two different ambient temperatures, a first ambient temperature threshold 62 below 45 degrees Fahrenheit and a second ambient temperature threshold 64 above 80 degrees Fahrenheit, and can be set and changed by the user 12.

As an example, the user normally leaves work at 4:30 pm and sets the remote-start program 10 to deliver the screen prompt 30 for a remote-start at 4:30 pm each weekday. At 4:30 pm on Tuesday the ambient temperature is 70 degrees Fahrenheit, which is below the second ambient temperature threshold 64 of 80 degrees Fahrenheit, therefore a cooldown period is not required, and the screen prompt 30 is therefore not generated on Tuesday at 4:30 pm. In this example on Wednesday at 4:30 pm the ambient temperature is 85 degrees Fahrenheit, which is above the second ambient temperature threshold 64 of 80 degrees Fahrenheit, which requires a cooldown period, therefore the screen prompt 30 is generated on Wednesday at 4:30 pm.

The user distance 28 between the user and the vehicle 16 can also be used as a criteria for generation of the screen prompt 30. The remote-start program 10 initiates the timer 34 when the user 12 parks and leaves the vehicle 16 and defines a radius around the parked vehicle 16 once the user 12 has moved the user distance 28 away from the vehicle 16. The screen prompt 30 requesting if the user 12 wants to initiate the remote-start operation 44 can be sent when the user 12 returns within the radius defining the user distance 28. Because the user 12 may have walked, traveled by taxi, taken a subway, or used other means of transportation after leaving the vehicle 16, the remote-start program 10 can also incorporate a time interval together with the user distance 28. For example, if a time to reach the user distance 28 is “X” minutes, if the user 12 normally returns to the vehicle at 4:30 pm, when the user 12 returns within the user distance 28 the remote-start program 10 will generate the screen prompt 30 “X” minutes ahead of 4:30 pm. The remote-start program 10 therefore comprehends and incorporates different modes of transportation including: walking, subway, bike, additional car ride, and the like. A recalculation is also performed at one or more intervals to determine if the user 12 is on track to arrive at the vehicle 16 within a projected timeframe. The remote-start program 10 generates the screen prompt 30 for the user 12 to restart the vehicle 16 if the projected time of arrival at the vehicle 16 is delayed.

The remote-start program 10 returns to a start step 66 after generation of the screen prompt 30 or after selection of the remote start operation 44 is made.

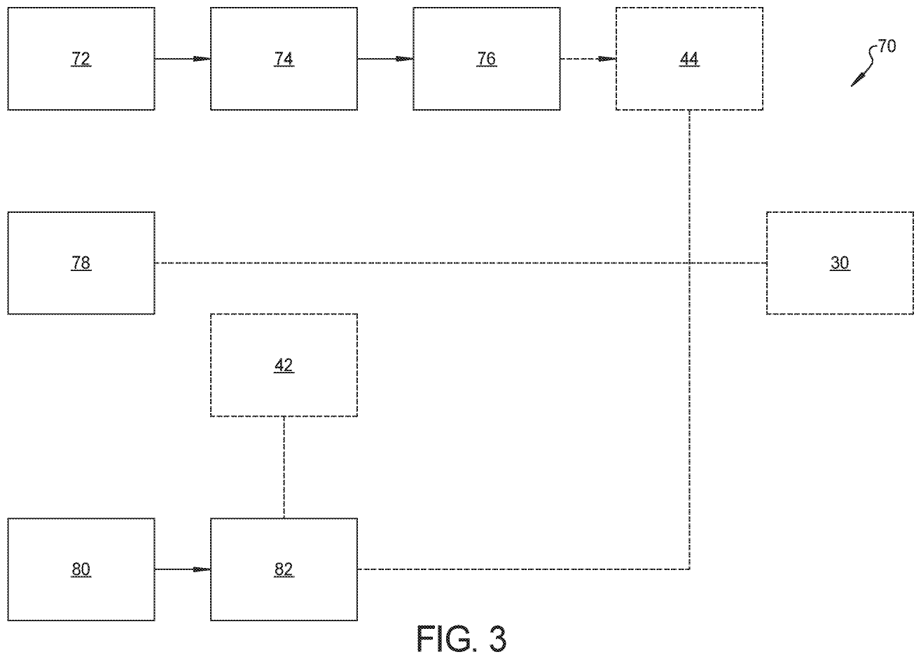

Referring to FIG. 3 and again to FIGS. 1 and 2, a second flow chart 70 provides multiple steps taken by the remote-start program 10. In a detection step 72 the remote-start program 10 provides the capability to detect if the user 12 started the vehicle 16 but did not enter the vehicle 16. As a fuel saving measure, at a time-out step 74, the vehicle 16 may time-out the remote-start operation when the user 12 does not enter the vehicle 16 within a predetermined time interval. In this event, the remote-start program 10 generates a repeat screen prompt 76 to ask the user 12 to repeat the remote start operation 44 if desired.

The remote-start program 10 also provides the capability to utilize a connected personal assistant service 78 including but not limited to Amazon Alexa, Google Home, or the like and will prompt the user 12 to conduct the remote-start operation 44 based on appointments, schedule, weather and traffic conditions that may be saved in the personal assistant service 78.

The remote-start program 10 further includes an integrated personal calendar 80 providing times to leave, such as a time to leave for work, a time to leave for home, a time of an appointment, and the like. Data populating the integrated personal calendar 80 can be loaded by the user 12. The screen prompt 30 to remote-start the vehicle 16 is created a predetermined number of minutes 82 retrieved from the memory 42 prior to each of the calendar set times.

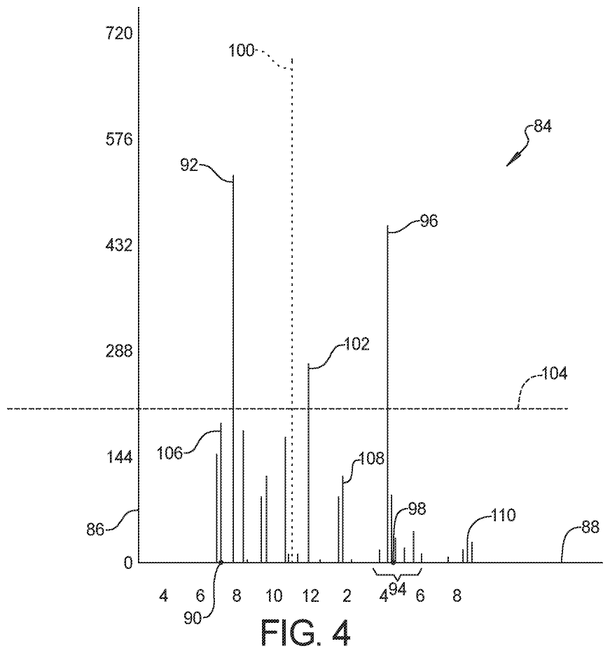

Referring to FIG. 4 and again to FIGS. 1 through 3, a graph 84 presents representative data collected for a quantity of user steps 86 over a time 88 in hours for an exemplary user work day. The remote-start program 10 uses the step-counter 32 to track a number of user steps taken during the work day. A vehicle shut-off 90 occurs at approximately 7:30 am which is monitored by the remote-start program 10, and the user 12 begins walking to the office, which is represented by a step count 92 of approximately 528 steps. Based on previously collected user data or from user input, a normal user leave time range 94 occurs between approximately 3:30 pm and 6:00 pm, therefore a spike step count 96 of approximately 480 steps occurring at 4:00 pm generates the screen prompt 30, which the user 12 responds to with a request for a vehicle remote start 98 occurring at approximately 4:15 pm.

To avoid excessive user notifications, the remote-start program 10 monitors multiple different step counts occurring during each user work day without generating the screen prompt 30. This is accomplished in several ways. During the work day after the vehicle shut-off 90 but before the user leave time range 94 occurs, multiple different step counts such as a step count 100 of approximately 700 steps occurs at 11:00 am and a step count 102 of approximately 280 steps occurs near lunch time of approximately 11:45 am. Because the step counts 100 and 102 occur prior to the user leave time range 94, the user 12 can designate to the remote-start program 10 to omit these events from generating the screen prompt 30. A second method to avoid unwanted screen prompts is provided by a user designated step cut-off level 104. The program 10 can provide an initial step cut-off level 104, which can then be modified by user 12 by setting the step cut-off level 104 at a desired step count, for example at 216 steps as shown. The step cut-off level 104 can therefore be modified based on user experience or preference. The step cut-off level 104 applies to automatically omit any step count below the predetermined number of steps from generating the screen prompt 30. The step cut-off level 104 is useful for omitting step counts such as a step count 106 occurring prior to the vehicle shut-off 90, at multiple times during the work day such as a step count 108 when the user 12 is moving about at work, or after work such as a step count 110 when the user 12 has returned home.

A remote-start program 10 of the present disclosure offers several advantages. These include the provision of a screen prompt on a personal communication device of a user which prompts the user to initiate a remote-start operation. The screen prompt is automatically generated under several predetermined conditions. These conditions include a predefined time of day being reached, a predefined barometric pressure difference identified signifying the user has changed elevation and is moving toward the vehicle, the user returning to a predefined user distance from the vehicle, or the user has taken a predefined quantity of steps at a designated time of the day signifying the user is moving toward the vehicle.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method for controlling an automobile vehicle remote-start operation, comprising:
collecting data directed to initiation of an automobile vehicle remote start operation;
comparing the data to at least one predetermined threshold; and
if the at least one predetermined threshold is met, generating a screen prompt displayed on a personal communication device of a user of the automobile vehicle requesting the user to initiate the remote-start operation.

2. The method of claim 1, further including designating the data as a quantity of steps taken by the user following a vehicle shut-off.

3. The method of claim 2, further including setting as the predetermined threshold a minimum quantity of the steps.

4. The method of claim 3, further including designating a time range within which to count the minimum quantity of the steps and omitting steps counted outside of the time range.

5. The method of claim 1, further including designating the data as a barometric pressure data set defining a first elevation defining a vehicle elevation and a second elevation defining a personal communication device elevation.

6. The method of claim 5, further including setting as the predetermined threshold an elevation difference between the first elevation and the second elevation.

7. The method of claim 1, further including:
designating the data as at least one of a work start time and a work end time of the user; and
setting as the predetermined threshold a predetermined time period ahead of the at least one of the work start time and the work end time.

8. The method of claim 1, further including:
detecting if the user started the vehicle but did not enter the vehicle; and
timing-out the remote-start operation when the user does not enter the vehicle within a predetermined time interval.

9. The method of claim 8, further including generating a repeat screen prompt to request the user to repeat the remote start operation.

10. The method of claim 1, further including:
designating the data as a user distance between the user and the vehicle;
initiating a timer when the user parks and leaves the vehicle;
defining a radius around the vehicle after the user has moved the user distance away from the vehicle; and
setting as the predetermined threshold a determination that the user has returned within the radius defining the user distance.

11. A method for controlling an automobile vehicle remote-start operation, comprising:
linking a personal communication device of a user to an automobile vehicle;
collecting data directed to initiation of an automobile vehicle remote start operation on the personal communication device;
comparing the data to a predetermined threshold;
if the predetermined threshold is met, generating a screen prompt and displaying the screen prompt on the personal communication device of the user requesting the user to initiate the remote-start operation; and
initiating the remote-start operation by the user from the personal communication device.

12. The method of claim 11, further including:
designating the data as a quantity of steps taken by the user following a vehicle shut-off; and
setting as the predetermined threshold a minimum quantity of the steps.

13. The method of claim 11, further including:
designating the data as a user distance the user has moved away from the vehicle;
setting a calculated time for the user to reach the user distance defining “X” minutes; and
defining the predetermined threshold as a predetermined time when the user will return to the vehicle.

14. The method of claim 13, further including:
identifying the user has returned within the user distance confirming the predetermined threshold is met; and
performing the generating step “X” minutes ahead of the predetermined time.

15. The method of claim 11, wherein the predetermined threshold includes:
a first barometric pressure identified at a first location where the vehicle is shut-off; and
a second barometric pressure confirmed at a second location designated by the user different from the first barometric pressure.

16. The method of claim 15, wherein the predetermined threshold is met when a predetermined third barometric pressure between the first barometric pressure and the second barometric pressure is identified by the personal communication device of the user indicating the user is returning to the vehicle.

17. The method of claim 11, further including:
designating the data as a quantity of steps taken by the user following a vehicle shut-off;
setting a user designated step cut-off level; and
applying the step cut-off level to automatically omit a count of the steps below a predetermined number of steps from generating the screen prompt.

18. A system to control an automobile vehicle remote-start operation, comprising:
a personal communication device of a user linked to an automobile vehicle;
a data set directed to initiation of an automobile vehicle remote start operation collected on the personal communication device;
a predetermined threshold compared to the data set;
a screen prompt generated by the personal communication device if the predetermined threshold is met, the screen prompt displayed on the personal communication device of the user, the screen prompt requesting the user to initiate the remote-start operation; and
wherein a selection of the screen prompt by the user acts to initiate the remote-start operation from the personal communication device.

19. The system of claim 18, wherein:
the data set defines a quantity of steps taken by the user following a vehicle shut-off; and
the predetermined threshold defines a minimum quantity of the steps.

20. The system of claim 18, wherein:
the data set defines at least one of a work start time and a work end time of the user; and
the predetermined threshold defines a predetermined time period ahead of the at least one of the work start time and the work end time.
